(19) United States
(12) Patent Application Publication
(10) Pub. No.: US 2022/0253771 A1
(43) Pub. Date: Aug. 11, 2022

(54) SYSTEM AND METHOD OF PROCESSING DATA FROM MULTIPLE SOURCES TO PROJECT FUTURE RESOURCE ALLOCATION

(71) Applicant: Introhive Services Inc., Fredericton (CA)

(72) Inventors: Amy PALMER, Fredericton (CA); Silvio VERZILLI,, Fredericton (CA)

(21) Appl. No.: 17/666,521

(22) Filed: Feb. 7, 2022

Related U.S. Application Data
(60) Provisional application No. 63/146,426, filed on Feb. 5, 2021.

(51) Int. Cl. G06Q 10/06

(52) U.S. Cl. CPC G06Q 10/06312

(57) ABSTRACT

Processing system for evaluating a customer opportunity based on multiple metrics, including automated tracking of communications activities with a customer, to determine when the customer opportunity has reached a defined milestone.

### CROSS-REFERENCE TO RELATED APPLICATIONS

This application claims the benefit of and priority to U.S. Provisional Patent Application No. 63/146,426, entitled “SYSTEM AND METHOD OF PROCESSING DATA FROM MULTIPLE SOURCES TO PROJECT LEAD QUALIFICATION”, filed Feb. 5, 2021.

### TECHNICAL FIELD

The present disclosure relates to the automated systems and methods for data analysis of data acquired from multiple sources for projecting when further resources should be allocated.

### BACKGROUND

Enterprises such as companies, accounting firms, law firms, universities, partnerships, agencies and governments commonly use Customer Relationship Management (CRM) technology and other automated systems to manage relationships and interactions with other parties such as customers and potential customers.

In particular, CRM systems typically employ electronic computing and communications devices that enable one or more of contact management, sales management, and calendar management with the objective of enhancing productivity. An important function provided by CRM systems is digital tracking and storage of data about third parties such as customers and potential customers.

Determining when to dedicate more resources to a particular project or opportunity can be challenging. For example, engagement with a potential customer or a particular customer can be commonly characterized as stages with respect to a sales cycle and/or a sales funnel. A sales cycle can be considered as a process for selling to a specific customer and can, for example, include a number of stages, for example, (i) lead identification (prospecting), (ii) connection, (iii) sales lead qualification, (iv) presentation, (v) overcoming objections and (vi) closing. A sales funnel can be considered as an aggregate view of all active sales cycles for an enterprise. A sales funnel may include a top stage that is intended to facilitate awareness among a broad audience, followed by stages that are increasingly focused on specific organizations and individuals with the objective of closing a sale. Top stage activities may for example be directed to a broad audience and facilitate general awareness (e.g., blog posts, social media updates, E-books, web-pages, audio podcasts, video podcasts, print advertising), whereas lower sales funnel stagesencompass typical customer specific sales cycle activities.

Typically, marketing lead qualification and sales lead qualification are considered benchmark or milestone events that will result in greater resource allocation. Marketing lead qualification can refer to when a particular potential customer is first identified through general marketing activities as participating in, or as a target for, further marketing activities. For example, a visitor to a website may fill out a form requesting further information. Marketing lead qualification may coincide with the “(i) lead identification” stage of the sales cycle process. Qualification of a potential customer as a qualified marketing lead can trigger the “(ii) connection” stage of the sales cycle process, resulting in more targeted sales and marketing activities. The “(iii) sales lead qualification” stage is the process of categorizing a qualified sales or marketing lead as a potential customer who is sufficiently engaged such that further, more aggressive steps in the sales cycle should be pursued. These further, more aggressive steps can include more allocation of enterprises resources such as technical and other resources. For example, in some use cases, sales lead qualification is used to trigger a handoff of a potential customer from a marketing group to a sales group. In some other use cases, marketing lead qualification is used to trigger a handoff of a potential customer from a marketing group to a general sales group, and sales lead qualification used a trigger to bring in more specialized sales people. Successful closing of an opportunity can result in a customer being classified as an active account.

There are solutions that exist today that will help a company generate leads. Marketing qualified leads can be worked by marketing or sales people to nurture the leads to sales qualified leads and that eventually can become a paying customer. Marketing representatives are required to review their communications with the leads and determine whether a prospect is a good possibility for a sale. For example, one sales methodology determines the fit based on their budget, if they have the authority, the need for the product and the timeline (BANT). Some problems with these systems are that the collection and analysis of data is subject to human interpretation, with the result that sales lead qualification is not always executed at the correct time. This can result in a company trying to move too quickly or too slowly into further stages or processes of the sales cycle, possibly leading to a customer alienation or an inefficient use of corporate resources (for example, the time of corporate employees, and inefficient use of corporate computing resources).

Traditionally, lead qualification as a human activity can be highly subjective and dependent on the perceptions of individual employee who may not have a complete knowledge of all available information about the target customer. For example, a particular employee may not have knowledge of when lead qualification in a particular industry or with a particular customer has historically generated a positive result for an opportunity.

Accordingly, there is a need for systems and methods that can enable a practical, technical and objective solution to processing a myriad of electronic data associated with a potential opportunity to enable an automated non-subjective decision as to when a benchmark condition is achieved such that further resources should be directed to that potential opportunity in a manner that optimizes the use of those resources.

### SUMMARY

According to a first aspect, a computer implemented method is disclosed for determining when an ongoing process between a first entity and a second entity has achieved a milestone, comprising: tracking, over time, electronic communications exchanged between the first entity and the second entity; computing when the milestone has been achieved based on a frequency of the electronic communications, participants of the electronic communications and a content of the electronic communications; and sending a notification when the milestone has been achieved.

### BRIEF DESCRIPTION OF THE DRAWINGS

Exemplary embodiments are illustrated in the referenced figures of the drawings. It is intended that the embodiments and figures disclosed herein are to be considered illustrative rather than restrictive.

FIG. 1 is a simplified block diagram illustrating opportunity analysis module in a computing environment that includes an enterprise network, CRM system and a CRM support system in accordance with example embodiments of the present disclosure.

FIG. 2 illustrates steps taken by the opportunity analysis module to generate a recommendation according to example embodiments.

FIG. 3 illustrates a block diagram of a computer system that can be configured to implement one or more processes and features of the methods and systems described.

Similar reference numerals may have been used in different figures to denote similar components.

### DESCRIPTION

Example embodiments will now be described more fully hereinafter with reference to the accompanying drawings, in which some, but not all, embodiments of the invention are shown. The features and aspects presented in this disclosure may be embodied in many different forms and should not be construed as limited to the embodiments set forth herein. Where possible, any terms expressed in the singular form herein are meant to also include the plural form and vice versa, unless explicitly stated otherwise. In the present disclosure, use of the term “a,” “an”, or “the” is intended to include the plural forms as well, unless the context clearly indicates otherwise. Also, the term “includes,” “including,” “comprises,” “comprising,” “have,” or “having” when used in this disclosure specifies the presence of the stated elements, but do not preclude the presence or addition of other elements.

As used herein, statements that a second item (e.g., a value, score, computation, prediction, or determination) is “based on” a first item can mean that characteristics of the second item are affected or determined at least in part by characteristics of the first item. The first item can be considered an input to an operation or calculation, or a series of operations or calculations that produces the second item as an output that is not independent from the first item.

Example embodiments described herein are directed to computer implemented systems and methods for determining when an opportunity with a customer has achieved a defined milestone, including for example when a lead for an opportunity can be designated as a sales qualified lead. The determination of the correct time to designate a lead as a qualified lead in an ongoing sales cycle can be based on information from several sources about the current lead, as well as historic information compiled from several sources for past opportunities.

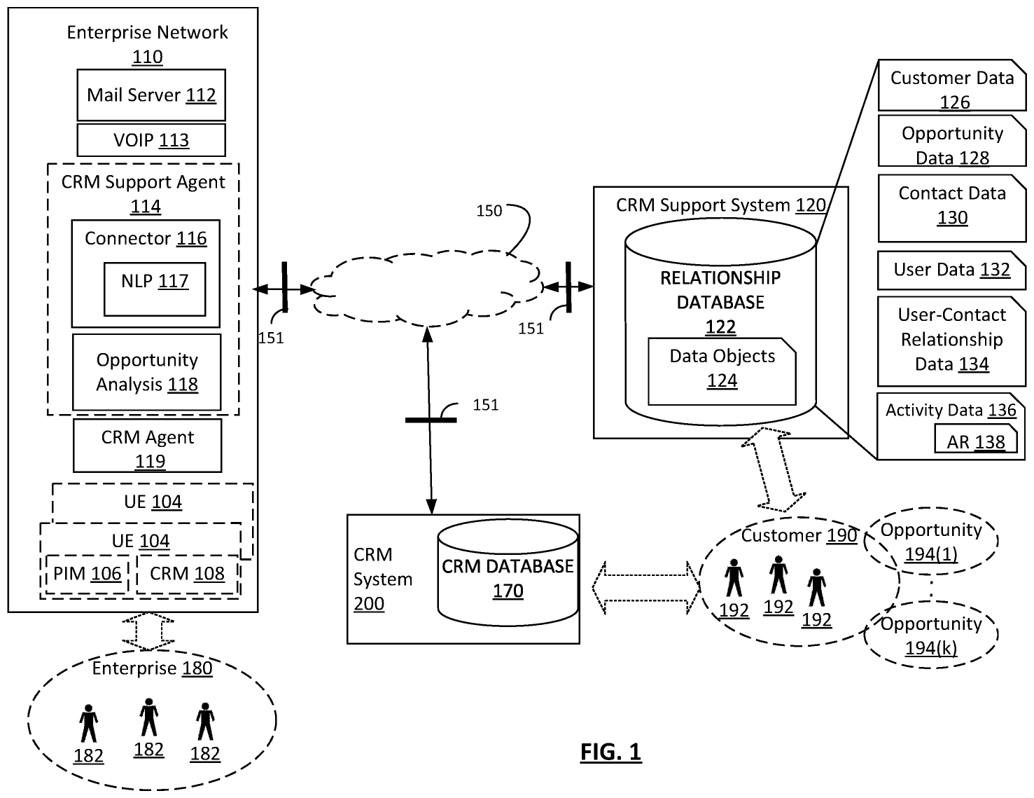

FIG. 1 illustrates an example of an automated, computer-implemented environment in which the methods and systems described in this disclosure may be implemented. In the example of FIG. 1, environment includes an enterprise network 110 that supports an enterprise such as a company, firm or other type of organization (referred to in this disclosure as “enterprise 180”) that is selling or otherwise providing a product or service. In example embodiments, a plurality of individuals are registered or otherwise associated with the enterprise network 110 as users 182 of the enterprise 180. These individual users 182 may for example be employees, owners, partners, consultants, volunteers, and interns of the enterprise 180. In some examples, enterprise 180 could have as few as one user 182, and in some examples, enterprise 180 may have thousands or more users 182.

At any given time, the enterprise 180 has, or is, pursuing commercial relationships with one or more external entities or third party organizations, referred to in this disclosure as “customers” 190. As used herein, “customer” can include existing or potential customers, clients or donors or other entities of interest to the enterprise, and may include, among other things, companies, partnerships, universities, firms, government entities, joint venture groups, non-government organizations, charities, other types of groups, and individuals. In short, a customer is a third-party entity that the enterprise has identified and is tracking information in respect of. Typically, each customer 190 will have an associated set of individual representatives or contacts, referred to in this disclosure as “contacts” 192, that are identified as contacts of the enterprise 180 in one or more electronic databases that are operated by or associated with enterprise 180. For example, the individual contacts 192 associated with a customer 190 may be employees, owners, partners, consultants, volunteers, and interns of the customer 190. Furthermore, at any given time the enterprise 180 will typically have completed or will be pursuing one or more opportunities 194(1) to 194(k) with customer 190 (with k being customer dependent and representing a total number of open and closed opportunities with a specific customer 190). In this disclosure, the reference “opportunity 194(j)” will be used to refer a generic individual opportunity with a customer 190, and “opportunities 194” used to refer to a generic group of opportunities with all customers 190. An opportunity 194(j) may for example be a sales opportunity to sell a product or service, and may have an opportunity lifetime (e.g., duration of time from recognition of existence of the opportunity to closing of the opportunity) that can be divided into a set of successive phases that can overlap with the stages of a sales cycle process. In a presently disclosed example, the phases of an active opportunity can be categorized as: (A) “pre-lead qualification”, and (B) “lead qualified”. By way of example, a pre-lead qualification opportunity can overlap with sales cycle process stages (i) lead identification (prospecting), (ii) connection; and (iii), and (B) a “lead qualified” opportunity can overlap with sales cycle process stages (iv) presentation, (v) overcoming objections and (vi) closing.

Enterprise network 110 can include a plurality of computer devices, servers and computer systems that are associated with the enterprise 180 and are linked to each other through one or more internal or external communication networks, at least some of which may implement one or more virtual private networks (VPN). Different stages can require different levels of support by enterprise network 110.

In example embodiments, the environment of FIG. 1 also includes a CRM support system 120, and a CRM system 200, each of which may also include one or more computer devices, servers and network systems. One or more of CRM support system 120 and CRM system 200 may, in some examples, be operated by third party organizations that are service providers to the enterprise 180 associated with enterprise network 110. CRM support system 120 and a CRM system 200 are configured to track customer data on behalf of enterprise 180.

In the illustrated example, enterprise network 110, CRM support system 120, and CRM system 200 are each connected to a common communication network 150. Communication network 150 may for example include the Intranet, one or more enterprise intranets, wireless wide area networks, wireless local area networks, wired networks and/or other digital data exchange networks. Respective firewalls 151 may be located between the communication network 150 and each of the enterprise network 110, CRM support system 120, and CRM system 200. In different example embodiments, one or more of the features, modules or functions of enterprise network 110, CRM support system 120, and CRM system 200 that are described herein could alternatively be implemented in common systems or systems within a common network. For example, some or all of the features or modules of one or both of CRM support system 120 and CRM system 200 could alternatively be hosted on one or more computer systems located within the enterprise network 110. Alternatively, in some examples, some or all or the agents, modules or systems included in FIG. 1 as part of enterprise network 110 could be remotely hosted (for example at CRM support system 120 or CRM system 200) and accessed by users 182 of the enterprise network 110 through network 150. The locations of various modules, engines, systems and databases as shown in FIG. 1 is illustrative of only one of many possible architecture configurations.

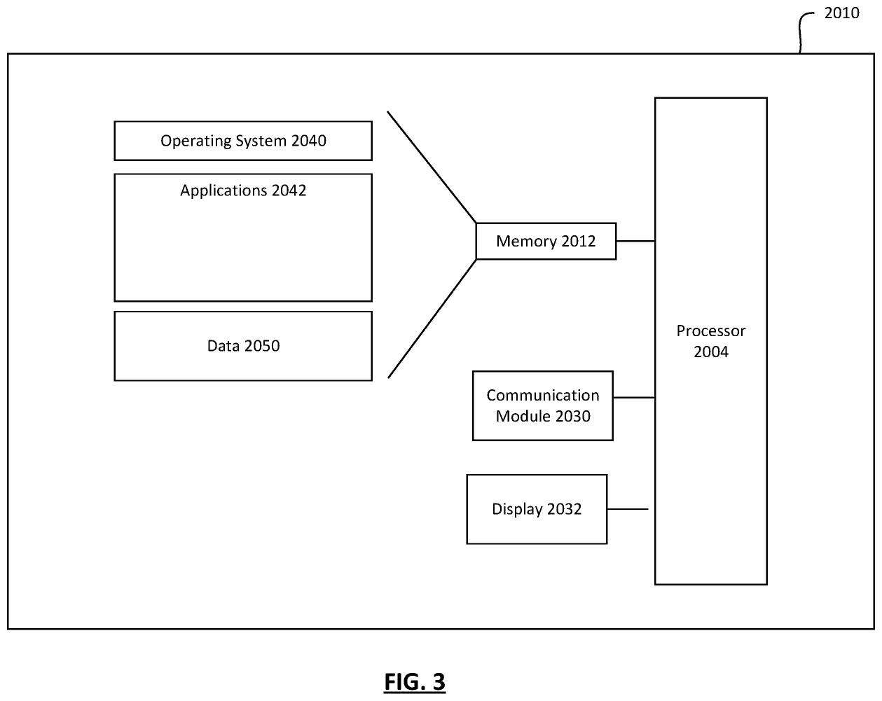

As used here, a “module” or “engine” can refer to a combination of a hardware processing circuit and machine-readable instructions (software and/or firmware) executable on the hardware processing circuit. A hardware processing circuit can include any or some combination of a microprocessor, a core of a multi-core microprocessor, a microcontroller, a programmable integrated circuit, a programmable gate array, a digital signal processor, or another hardware processing circuit. For example, a hardware processing circuit can include components of a computer system 2010 as described below in in respect of FIG. 3. A database or data storage can refer to a collection of information that is stored in an electronically accessible format using a non-transitory storage medium.

Enterprise Network 110

Enterprise network 110 includes at least one mail server 112 for handling and delivering external email that enterprise network 110 exchanges with remote mail servers through communication network 150. Thus, mail server 112 contains emails sent/received by the enterprise associated with enterprise network 110. In some examples, mail server 112 may also handle internal emails that are internal within the enterprise network 110.

In some examples, Enterprise network 110 includes at least one voice over internet protocol (VOIP) system 113 handling internal and external telephone communications. VOIP system 113 may be configured to log information about incoming and outgoing calls, including phone numbers and associated participant identifying data, timestamp information regarding start and stop times. In some example's VOIP system 113 supports voice messaging that enables incoming messages to be recorded. In some examples, VOIP system 113 may enable incoming and outgoing calls to be recorded.

In example embodiments, enterprise network 110 includes a CRM agent 119 that provides the enterprise network 110 with an interface to CRM system 200.

In example embodiments, enterprise network 110 also includes a CRM support agent 114 that provides the enterprise network 110 with an interface to CRM support system 120. In example embodiments, CRM support agent 114 includes a connector 116 that functions as an interface module between components of the enterprise network 110 and the CRM support system 120. For example, connector 116 is configured to interact with systems within the enterprise network 110 (such as mail server 112, VOIP system 113 and user equipment (UE) devices 104) to extract information about activities (such as communication activities and other enterprise-customer interaction activities) and provide that information to CRM support system 120.

In example embodiments, enterprise network 110 supports a plurality of UE devices 104. Each enterprise user 182 is associated with one or more respective UE devices 104. In example embodiments, a UE device 104 may be a smartphone, computer tablet, laptop computer, desktop personal computer, wearable electronic device or other communication enabled computer device. In example embodiments, UE devices 104 are configured with a personal information manager (PIM) module 106. Among other things, the PIM module 106 includes an email client, as well as one or more other functions such as calendaring, task managing, contact managing, note-taking, journal logging, and web browsing functions. The PIM module 106 will typically store associated PIM data that includes, among other things, user calendar data, user address book data, user email data and user messaging data. Examples of PIM modules 106 include modules that support basic communications and scheduling services that the user of a UE device 104 is registered with, such as Google Gmail™, Microsoft Outlook Exchange Web Service, and/or Lotus Domino. In example embodiments, some or all of the PIM data associated with a user 182 may be stored locally on the UE device 104 associated with the user, and in some examples, all or parts of the PIM data may be stored at a remote server hosted by or for enterprise network 110 that is accessible through a communication network to the UE device 104. In various embodiments, some or all of the PIM data for users 182 that is stored at UE devices 104 or other remote server is accessible to CRM support agent 114. In some examples, one or more connectors 116 are associated with CRM support agent 114 to enable the CRM support agent 114 to periodically retrieve the PIM data of registered users 182.

In example embodiments, UE devices 104 each include a CRM support client 108 that is configured to interface with the connector 116 of CRM support agent 114 to support the systems and methods described herein, including the exchange of PIM data described above. In example embodiments, a user 182 may have multiple associated UE devices 104 across which PIM data is synchronized. In some examples, a UE device 104 associated with a user could be a virtual device (e.g., a user virtual desktop) that is hosted by a server within enterprise network 110 and accessed by a remote access device (e.g., a thin client device).

In example embodiments, the CRM support client 108 of a UE device 104 has access to (or includes selected functionality of) an opportunity analysis module 118 that is configured to compute when further entity resources should be allocated to an opportunity. In some examples, opportunity analysis module 118 performs this function by performing a lead qualification analysis to compute when a lead can be designated as a sales qualified lead, as described below.

CRM System 200

In example embodiments, CRM system 200 may be implemented using a known CRM solution such as, but not limited to, Salesforce.com™, Microsoft Dynamics™, InterAction™ or Maximizer™, and includes a CRM database 170 that includes customer data (e.g., CRM data) for customers 190 that are tracked by enterprise 180. The CRM data that is stored in a CRM database 170 for an customer 190 may for example include: (I) general customer data, (II) opportunity data about specific opportunities that the enterprise has undertaken in the past, is currently undertaking, or is proposing to undertake in the future with customer 190, and (III) individual contact data that includes contact information for individual contacts who are members of the customer 190.

CRM Support System 120

In example embodiments, CRM support system 120 is configured to provide enhanced CRM information and functionality that supplements CRM System 200. CRM support system 120 includes a relationship database 122 for storing relationship data generated in respect of the customers 190 of interest to enterprise 180. In example embodiments, similar to CRM database 170, relationship database 122 may store, in respect of each customer 190 (e.g., each customer or client of enterprise 180), relationship data objects 124 that include: (I) customer data 126 that provide general information about the customer 190, (II) opportunity data 128 about specific opportunities that the enterprise has undertaken in the past, is currently undertaking, or is proposing to undertake in the future with the customer 190, (III) individual contact data 130 that includes contact information for individual contacts 192 (e.g., employees) who are associated with the customer 190, (IV) user data 132, that includes information about enterprise users 182 who are involved in the relationship with an customer 190, (V) user-contact relationship strength data 134, and (VI) activity data 136 that includes information about activities between enterprise 180 and customer 190. The data in relationship database 122 may include some or all of the information stored at CRM database 170, as well as supplemental information. In some examples, relationship database 122 includes links or other references to data stored at CRM database 170

In example embodiments, the CRM Support System 120 interfaces with connector 116 of CRM support agent 114 and other possible data sources to collect and update of data stored in relationship database 122. In some examples, the CRM support system 120 is configured to periodically refresh (e.g., for example on a timed cycle such as once every 24 hours) the content of data objects 124 such that the data maintained in relationship database 122 always includes current or near-current information. The CRM support system 120 may periodically refresh the information stored in relationship database 122 based on information from a plurality of sources. For example, CRM support system 120 may obtain data from the CRM database 170 of CRM system 200, from sources within enterprise network 110, and from other data sources that are available through communication network 150.

Customer data 126: As noted above, “customer” can refer to any third-party entity that the enterprise has identified and is tracking information in respect of. In example embodiments, the basic data included in customer data 126 stored at relationship database 122 may include, for each customer 190, some or all of the fields listed in the following Table 1, among other things:

TABLE 1
Customer Data Fields:

| Field | Field Description |
|---|---|
| Enterprise ID | Unique identifier assigned to |
| | Enterprise 180 |
| Customer ID | Unique identifier assigned to |
| | Customer 190 |
| Customer Industry Code | Code that identifies primary industry |
| | type of customer organization (e.g., |
| | Standard Industrial Classification |
| | (SIC) Code and/or North American |
| | Industry Classification System |
| | (NAICS) Codes) |
| Number of Employees | Number of Employees of Customer |
| | Organization |
| Customer Size Score | Score assigned based on size of |
| | customer organization (e.g., |
| | organization size of 1500+ |
| | employees = 10 points; 1000 to |
| | 1500 = 9 points; 750-1000 = 8 |
| | points, etc.) |
| Customer Annual Revenue | Annual Revenue of customer |
| | organization for one or more |
| | previous years |
| Owner User ID | User ID of enterprise user 182 who |
| | owns the customer (e.g., user 182 |
| | who has primary responsibility for |
| | enterprise-customer relationship) |
| Name | Name of Customer (e.g., company |
| | or organization name) |
| Top User-Customer Relationship | The enterprise user 182 that has the |
| | strongest relationship with the |
| | customer 190 |
| Account Status Indicator | One or more indicators to indicates |
| | Current Status of Customer (e.g., |
| | “Active Account” can indicate a |
| | customer with an ongoing |
| | commercial relationship with the |
| | enterprise (e.g., an opportunity has |
| | been successfully closed with the |
| | customer); “Open Opportunity” can |
| | indicate that an opportunity is being |
| | pursued with the customer but is not |
| | yet closed, can be linked to an |
| | opportunity ID); “Inactive Account” |
| | can indicate a customer that is no |
| | longer in a commercial relationship; |
| | “Prospecting” can indicate an entity |
| | that that is in the system but not yet |
| | an account. |

Opportunity data 128: In example embodiments, unique opportunities with an account may be tracked using specific opportunity records. In some examples, an opportunity record may not be created until an opportunity associated with a customer has reached a designated level, for example the qualified lead stage; in such cases, the Customer data may include account status indicator of “open opportunity” with or without an assigned opportunity ID.

The basic data included in opportunity data 128 stored at relationship database 122 may include, for each opportunity 194 with each customer 190, opportunity records that include some or all of the fields listed in the following Table:

TABLE 2
Opportunity Data Fields:

| Field | Field Description |
|---|---|
| Opportunity ID | Unique identifier assigned to |
| | Opportunity (May be same as |
| | Customer ID in some examples. |
| | e.g., where customer is treated as |
| | single opportunity) |
| Customer ID | Customer ID of the customer that is |
| | the target of the opportunity |
| Created Date | Date opportunity registered with |
| | CRM support system |
| Closed Indicator | Indicates if opportunity is closed |
| Closed Date | Date Opportunity was closed |
| Current Stage Indicator | Indicates current stage of open |
| | opportunity (e.g., (i) find leads |
| | (prospecting), (ii) connect, (iii) |
| | qualify leads, (iv) present, (v) |
| | overcome objections and (vi) close.) |
| Phase Indicator | Indicates if opportunity is a pre- |
| | sales qualified lead or a sales- |
| | qualified lead. |
| Enterprise - Customer Interaction | Indicators for one or more trends in |
| Trend Indicator(s) | interactions between Contact |
| | Participants and User Participants |
| | over one or more defined time |
| | periods |
| Won Indicator | Indicates opportunity closed |
| | successfully (e.g., with a sale) |
| Opportunity Size Score | Score that represents a size or |
| | dollar value of the opportunity |
| Projected Budget | Indicates current and historic |
| | projected budget of Customer for |
| | opportunity |
| Budget Trend Indicator | Indicates tends in projected budget |
| | amount |
| Product/Service ID | ID(s) of products or services that |
| | opportunity relates to |
| Product/Service Units | Projected number of units of product |
| | or service that opportunity will |
| | require |
| Main Contact ID | Contact ID of primary contact for |
| | opportunity with the customer |
| Main User ID | Contact ID of primary user for |
| | opportunity |
| Contact Participants | Contact ID's for all customer |
| | contacts that have been identified as |
| | participating in the opportunity |
| User Participants | User ID's for all enterprise users |
| | that have been identified as |
| | participating in the opportunity |
| Last Activity Date | Date of most recent activity |
| | recorded in respect of opportunity |
| Event ID | ID of marketing event that resulted |
| | in Opportunity (if known) |

Opportunity data may be updated over time as the opportunity 194 progresses, with updates being timestamped. Initial information about an opportunity 194 may be initially provided by an authorized user 182 at the time that an opportunity 194 is opened. In at least some examples, some or all of the opportunity data is stored in the CRM database 170 and is linked to or referenced by the relationship database 122.

Contact data 130: In example embodiments, the basic data included in contact data 130 stored at relationship database 122 may include, for each contact 192 at customer 190, contact records that include some or all of the fields listed in the following Table 3, among other things:

TABLE 3
Contact Data Fields:

| Field | Field Description |
|---|---|
| Contact ID | Unique contact identifier |
| Active/Inactive Indicator | Indicates if contact is active or |
| | inactive |
| Date Created | Date contact added |
| Customer ID | Customer ID of the customer the |
| | contact is associated with (referred |
| | to as “contact's customer”) |
| Department | Name of contact's department in |
| | contact's customer |
| Department ID | Numerical value that maps to |
| | Department (based on pre-defined |
| | mapping rules) |
| Customer Industry Code | Industry Code for contact's |
| | customer |
| Position/Title | The position/title of the contact in |
| | contact's organization |
| Title Score | Hierarchal Score assigned to Contact |
| | based on contact's position at |
| | contact's organization (e.g., may be |
| | defined by a look up table that maps |
| | position titles to scores: president = |
| | 20 points, CEO = 20 points, VP = 18 |
| | points, senior manager = 14 points; |
| | partner = 16 points, etc.) |
| Contact-Enterprise Relationship | Score That Indicates Perceived |
| Score | Value of the Relationship with the |
| | Contact |
| First Name | Contact's First Name |
| Last Name | Contact's Last Name |
| Full Name | Contact's Full Name |
| Primary Email | Contact's Primary Email |
| Primary Phone | Contact's Primary Phone |
| Preferred Marketing Event | Preferred Event Type for Contact |
| Contact Origination Type | Type and ID of activity or event that |
| | caused contact to be added as an |
| | Active Contact (e.g., email |
| | communication activity, meeting |
| | communication activity, new outlook |
| | or other personal information |
| | management system contact |
| | addition) |
| Image | One or more images obtained from |
| | on-line sources (e.g., Linked-In ™ |
| | profile picture) |
| Opportunity ID(s) | ID's of open and closed |
| | opportunities that the contact is or |
| | has participating(ed) in |

As noted above, contacts can be indicated as active or inactive. In example embodiments, an active contact can be a contact that has been a party to an activity (as tracked in activity data 136 below) within a predefined prior time period (e.g., last 18 months) and/or meets other pre-defined criteria including for example criteria as set by privacy and solicitation legislation or regulations. Inactive contacts are contacts that are not currently active and may in some examples be classified in one or more categories such as inactive historic contacts (e.g., contacts that were previously active contacts), and inactive prospective contacts (e.g., contacts working in industries that are of interest to the enterprise or with active customers, but who are not historic contacts).

User data 132: In example embodiments, the basic data included in user data 132 stored at relationship database 122 may include, for each user 182 that has a relationship with a contact 192 at the customer 190, user records that include some or all of the fields listed in the following Table 4, among other things:

TABLE 4
User Data Fields:

| Field | Field Description |
|---|---|
| User ID | Unique user identifier |
| User ID | User ID of the subject user |
| Department | Name of user's department in the |
| | enterprise organization |
| Title | Title/position of user within |
| | enterprise organization |
| User-Customer Relationship | Score That Indicates Perceived |
| Score(*) | Value of User's Relationship With |
| | Customer |
| Opportunity ID(*) | Opportunity ID for opportunity for |
| | which user is member of the |
| | enterprise team (e.g., selling team) |

(*)indicates fields that can be repeated for multiple customers/opportunities

User-Contact Relationship data 134: In example embodiments, the basic data included in user-contact relationship data 134 stored at relationship database 122 includes information for each known user-contact relationship that exists between a user 182 within enterprise 180 and a contact 192 within an customer 190. User-contact relationship records included in user-contact relationship data 134 may, for example, include some or all of the fields listed in the following Table 5, among other things:

TABLE 5
User-Contact Relationship Data Fields:

| Field | Field Description |
|---|---|
| User ID | Unique user identifier |
| Contact ID | Contact Unique Identifier |
| Customer ID | Contact's Customer ID |
| Start Date | Date when relationship between |
| | user and contact started |
| Relationship Origination Indicator | Activity ID and/or event ID of the |
| | activity/event that first triggered |
| | Contact/user relationship |
| Active Indicator | Indicates if relationship is currently |
| | active |
| User-Contact Relationship Score | Score that indicates perceived |
| | strength of User-Contact |
| | Relationship Strength |
| Last Activity Date | Date of last recorded activity |
| | including user and contact |

Activity data 136: In example embodiments, the activity data 136 stored at relationship database 122 may include data for activities related to the entity-customer relationship. Activities may for example include communication activities and documentation activities among other things. Activity data 136 may include respective activity records 138 for each logged activity. Table 6 below provides a generic example of fields that may be included in an activity record 138, depending on the type of activity and availability of information:

TABLE 6
Activity Data Fields:

| Field | Field Description |
|---|---|
| Activity ID | Unique identifier assigned to activity |
| Customer ID* | Identity of Customer whose contacts |
| | participated in the activity |
| Opportunity ID* | Identity of the opportunity(ies) that |
| | activity related to |
| Organizer ID | User ID of enterprise user that |
| | organized activity (e.g., email |
| | sender or meeting organizer) |
| Activity Type Indicator | Value that identifies the type of |
| | enterprise-customer interaction |
| | activity (e.g., (i) communication |
| | activity: incoming email, outgoing |
| | email, incoming meeting |
| | request/calendar invite, outgoing |
| | meeting request/calendar invite, |
| | incoming phone call, received |
| | voicemail message, outgoing phone |
| | call, in-person meeting, outgoing |
| | voicemail message, virtual meeting, |
| | combination of in-person and virtual |
| | meeting (ii) documentation activity: |
| | proposal submitted, draft statement |
| | of work (SOW) submitted; final |
| | SOW submitted; contract submitted |
| | for review). |
| Document ID | ID of document template (can be |
| | used to identify content of standard |
| | form email in the form of a |
| | communication action, or to identify |
| | document template in case of |
| | documentation activity) |
| Start Time | Date and time stamp indicating start |
| | of activity |
| Activity Duration and/or End Time | Duration of activity (e.g., length of |
| | meeting or phone call), or data and |
| | time stamp indicating end of activity |
| NLP Data | Word/Phrase/topical data extracted |
| | from text of written or transcribed |
| | verbal communication activities |
| Sentiment Indicator | Indicator provided manually or by |
| | NLP algorithm as to sentiment of |
| | activity (e.g.: negative to positive |
| | sentiment on scale of 1 to 5, in |
| | example embodiments, may be |
| | determined at CRM support agent |
| | 114 and sent by connector 116 to |
| | data tracking module 122) |
| Content Count* | Counts number of occurrences of |
| | predefined words in communication |
| | activity (e.g., product name, |
| | competitor product name). (In |
| | example embodiments, may be |
| | determined at CRM support agent |
| | 114 and sent by connector 116 to |
| | data tracking module 122) |
| Participants - Customer* | Contact IDs or other available |
| (ID/Title/Department) | identifier and title/department |
| | information for all individuals |
| | involved on customer side who were |
| | invited |
| Participants - Enterprise* | User IDs or other available identifier |
| (ID/Title/Department) | and title/department information for |
| | all individuals involved on enterprise |
| | side of activity |
| Subject | e.g., Information included in email |
| | Subject fields or meeting “Subject” |
| | field by meeting organizer. |
| Location | e.g., Information included in |
| | meeting “Location” field by meeting |
| | organizer |
| Additional Information | Additional descriptive information |
| | about activity (e.g., information |
| | included in the open format field of |
| | a meeting scheduling form) |
| Average Enterprise-Contact | Average Enterprise-Contact |
| Relationship Score | Relationship Score of Customer |
| | participants |
| Average Title Score | Average Title score of Customer |
| | participants |

*Indicates fields that will be repeated as required

Data Object Storage and Collection: In example embodiments, the CRM support system 120 includes both current and historic records in data objects 124, enabling changes in data, including data of the type included in the data object fields noted above, to be compared and plotted over time. For example, current and historical time-stamped versions of the records (or selected data fields) included as data objects 124 may be stored at relationship database 122.

The data included in data objects 124 in relationship database 122 may be obtained by CRM support system 120 from different sources using different methods. For example, some information may be collected from enterprise users 182 through data entry provided through user interfaces supported by CRM support agent 114. Some information may be gathered from third party data providers (e.g., contact information and customer information pertaining to inactive prospective customers and contacts, and supplementary information regarding contacts 192 and customers 190). Some information may be gathered directly or indirectly (for example via CRM agent 119) from CRM system 200. Some information may be gathered through automated monitoring of enterprise network 110 activities and events, including activities at mail server 112 and UE device PIM 106 activities such as email activities, calendar activities and contact management activities. CRM support system 120 may be configured to perform periodic email, calendar and contact synchs with CRM support agent 114 for updates.

By way of example, in the case of activity data 136, in example embodiments, CRM support agent 114 is configured to automatically collect information about communication activities between users 182 associated with the enterprise 180 and external contacts 192 associated with an customer 190. These communication activities may for example be electronic communications such as email, meetings that are tracked in calendar systems and/or scheduled through email communications, and telephone calls that occur through a VOIP system 113 that enables call logging. Each of these interactions have associated electronic data that includes a contact identifier (e.g., email address or phone number for contact 192), time stamp information for the interaction, and a user identifier (e.g., data that identifies the user(s) 182 of the enterprise 180 and customer contacts 192 that were involved in the communication activity).

In example embodiments, CRM support agent 114 is configured to collect the information about communication activities by interacting with devices and systems that are integrated with enterprise network 110 and generate reports that are sent to CRM support system 120 automatically on a scheduled basis or when a predetermined threshold is met or a predetermined activity occurs. In some examples, CRM support agent 114 may collect information from an enterprise mail server 112 and VOIP system 113 located within enterprise network 110 and/or from PIM modules 106 associated with UE devices 104, via the connector 116.

In some examples, connector 116 may collect information from the mail server 112. For example, in some embodiments connector 116 is configured to intermittently run a batch process to retrieve email messages from the mail server 112 so that communication activity data can be derived from the email messages and provided through communication network 150 to the relationship database 122. In some examples, the connector 116 is configured to extract selected information from email messages as contact interaction data and other metadata. For each email message, the extracted information may for example include any external email address included in the sender, recipient and carbon copy (CC) and blind carbon copy (BCC) recipient email address fields, along with a send or receive timestamp applied to the email message by the mail server 112. In example embodiments, the extracted information can also include information that identifies any enterprise users 182 that are participating in the email as sender or recipient or CC recipient. In example embodiments, the extracted information can also include information that identifies any customer members 192 that are participating in the email as sender or recipient or CC recipient.

In example embodiments, meeting requests and invites will be included among the email messages that are processed by mail server 112, and connector 116 is configured to include email addresses in the meeting invitee list and organizer fields in the contact interaction data extracted from the emailed meeting invite. In some examples, connector 116 may also be configured to interface with CRM support clients 108 to receive data from the PIM modules 106 of UE devices 104 associated with the enterprise network 110. In some examples where enterprise network 110 supports phone call logging, for example in Voice-Over-Internet-Protocol (VOIP) implementations supported by a VOIP system 113, connector 116 may be further configured to interact with a VOIP server to collect information such as metadata about external phone numbers used for outgoing and internal calls, and timestamp information, for inclusion in communication activity data.

In at least some examples, in addition to collecting metadata (e.g., information about participants, time stamps, etc.) about communication activities, CRM support system may also collect substantive information. In some examples, that information could be the actual text of information that is include in electronic communications such as emails, text messages, calendar invites. In some examples, a speech to text conversion engine may be used to transcribe audio data from communication events such as phone calls, video conferences and voice mail messages that occur through enterprise network 110, and that text could be stored as part of the activity data.

In some examples, text from electronic messages or text obtained from verbal communication transcriptions may be analyzed and abstracted using an natural language processing (NLP) module that has been trained or otherwise configured to generate vector embeddings that indicate content of interest (including for example, embeddings that represent one or more of word level content, phrase level content, word grouping topical content and/or a sentiment). In some examples, such NLP embedding may be performed at the enterprise network 110. For example, connector 116 may include an NLP module 117 that is configured to generate embeddings in respect of electronic and audio communications activities and provide that information to CRM support system 120. Among other things, NLP module 117 can perform filtering, text classification and sentiment analysis functions that can enable the substantive content of communications activities to be represented as numeric tensors that can be processed using automated solutions (examples of which will be discussed in greater detail below).

Relationship Scoring

It will be noted that a number of the data objects 124 include relationship scoring information that assign values to relationships based on metrics described in greater detail below. For example, relationship scores can include: customer data 126 includes a “Top User-Customer Relationship” that identifies the enterprise user 182 that has a highest overall relationship score with the subject customer 190; contact data 130 includes a “Contact-Enterprise Relationship Score” that that indicates a perceived value of the relationship of enterprise 180 with the subject contact 192; user data 132 includes a “User-Customer Relationship Score” that indicates perceived value of user's relationship with contact; and user-contact relationship data includes a “User-Contact Relationship Score” that indicates perceived strength of the user-contact relationship.

According to example embodiments, the CRM support system 120 is configured with a set of relationship score prediction models for computing each of the respective relationship scores. In at least some examples, these scores are calculated by CRM support system 120 based on communication activities between enterprise users 182 and customer contacts 192, such as the communications activities that are tracked as part of activity data 136. By way of example, the user-contact relationship score for an enterprise user 182-customer contact 192 could be based on a communication score that is based on features such as, among other things: activity type (e.g., incoming email, outgoing email, incoming meeting request/calendar invite, outgoing meeting request/calendar invite, incoming phone call, outgoing phone call, in-person meeting, on-line meeting, video conference); frequency (e.g., number of communication activities with a defined time period); recentness of communication activities; and length of communication activity, among other things.

By way of illustrative non-limiting example, a communication score based on frequency of communication, recentness of communication, and type of communication could be determined based on a pre-defined model or algorithm such as follows:

Raw communication score=(total number incoming emails in last week from contact listing user as direct or CC recipient)*(W1)+(total number outgoing emails in last week from user listing contact as direct or CC recipient)*(W2)+(total number of phone calls,in-person meetings, and virtual meetings involving both user and contact in last week)*(W3)+(total number incoming emails in last month from contact listing user as direct or CC recipient)*(W4)+(total number outgoing emails in last month from user listing contact as direct or CC recipient)*(W5)+(total number of phone calls, in-person meetings, and virtual meetings involving both user and contact in last month)*(W6)+(total number incoming emails in last 6 moths from contact listing user as direct or CC recipient)*(W7)+(total number outgoing emails in last six months from user listing contact as direct or CC recipient)*(W8)+(total number of phone calls, in-person meetings, and virtual meetings involving both user and contact in last week)*(W9)+(total number of all communications activities involving both user and contact over lifetime of user-contact relationship)*(W10)

Where: W1 to W2 are predetermined weights. (e.g., W1=W2=7; W3=8, W4=W5=5, W6=6; W7=W8=3; W9=4; W10=1).

In further example embodiments, the communication score may be determined using a learned model that has been learned using machine learning techniques based on historic communication and relationship data.

In example embodiments the raw communication score may be normalized to a communication score based on comparison with historical data and/or data for other user-contact relationships or other scaling methodology to a range (for example 0 to 1). In some examples, the normalization may be based on data limited to the enterprise. In some examples, the normalization may be based on data from an industry. In some examples, normalization may be related to a specific customer. In some examples, a communication momentum value may be based on trends over time in the metrics represented in the raw score calculation noted above.

In some examples a User-Contact Relationship Score could be a composite of the contacts title score and a communication score based on the above attributes (e.g., contact title score*communication score). In some examples the User-Contact Relationship Score may be decided based only on the communication score. In some example embodiments, User-Contact Relationship Score could be represented as a discrete ranking within a relative scale such as “3=high”, “2=medium”, “1=low”.

In some examples, “Contact-Enterprise Relationship Score” could be based on a combination (e.g., sum or product) of all of the individual User-Contact Relationship Scores that a contact 192 has with users 182 of enterprise 180. In some examples, a “User-Customer Relationship Score” could be based on a combination (e.g., sum or product) of all of the individual User-Contact Relationship Scores that a user 182 has with customer contacts 192. In some examples, the “Contact-Enterprise Relationship Score” could be based on a combination of all the individual User-Contact Relationship Scores across all user-contact relationships between an enterprise 180 and an customer 190.

Further examples of relationship scoring techniques that can be applied are described in U.S. Pat. No. 9,633,057, issued Apr. 25, 2017, the content of which is incorporated herein by reference.

Communication Trend Analysis

As indicated above, opportunity data can include one or more Enterprise—Customer Interaction Trend Indicator(s) that can indicate one or more trends in interactions between Contact Participants and User Participants over one or more defined time periods. According, in example embodiments, the CRM support system 120 is configured with one or more communication trend prediction models for computing one or more respective Enterprise—Customer Interaction Trend Indicator(s) in respect of opportunities, as follows.

In an example embodiment, a communication score trend indicator for an opportunity may be determined by determining trends in communication scores between the users and contacts who are participating in an opportunity. A downward trend may indicate a loss of interest, whereas an upward trend may indicate that an opportunity is ready to move to the sales qualified lead phase. In some examples, a communication score trend indicator could be based on a subset of the participants (for example the main user and main customer contacts). In some examples, a communication score trend indicator could be based on all the opportunity participants.

In an example embodiment, a relationship score trend indicator for an opportunity may be determined by determining trends in one or more of the user-contact, user-customer, contact-entity, and/or enterprise-customer relationship scores for the participants in an opportunity. A downward trend may indicate a loss of interest, whereas an upward trend may indicate that an opportunity is ready to move to the sales qualified lead phase.

In further examples, other Enterprise—Customer Interaction Trend Indicators can be determined based on criteria other than that used in the above identified relationship and communication scores, based on the activity data that is acquired through monitoring of one or both of mail server 112 and VOIP 113. For example, response time to electronic communications, including for example, the response time by customer contacts to emails from participant users can be tracked. A decrease in response times (i.e., customer contacts start responding more quickly than before could indicate increased interest or that they are gaining some momentum internally) can indicate that an opportunity is heating up. Conversely, if the customer contacts suddenly takes much longer to respond, that could be indicative of a waning interest and should be flagged as an early warning sign that an opportunity is potentially running into issues.

In some examples, the Enterprise—Customer Interaction Trend Indicators could include a semantic trend based on the evolving language used in user contact communications over time that are captured by NLP module 117

Trends in meetings (including frequency of in-person or on-line meetings and or the number of customer contact participants) can also be used to generate Enterprise—Customer Interaction Trend Indicators, with increasing trends treated positively and negative trends treated negatively.

Opportunity Analysis—Lead Qualification

Example embodiments described herein are directed to computer implemented systems and methods for objectively determining when an increase in enterprise resources should be directed towards an opportunity. For example, this determination can be based on a conclusion that an opportunity with a customer can be transitioned from a pre-lead qualified phase to a lead qualified state. In examples, this transition can coincide with completion of stage (iii) of the sales cycle, namely designation of a lead as a qualified lead. In example embodiments, an opportunity analysis module 118 interacts with components of the system of FIG. 1 to make a determination as to whether a particular opportunity lead can be designated as a qualified lead. Designation as a qualified lead can be used to determine further activities that are to be taken in respect of the opportunity. In the illustrated embodiment, opportunity analysis module 118 is shown as part of CRM support agent 114. However, some or all of the functionality of opportunity analysis module 118 could be performed at one or more of the other components shown in FIG. 1, including CRM system 200, in alternative embodiments.

In an example embodiment, the opportunity analysis module 118 is configured to generate a lead qualification decision for a specific opportunity with a customer 190. In example embodiments, opportunity analysis module 118 may be configured to automatically evaluate, on a periodic basis, all customer opportunities that are in the marketing lead qualified phase and have not yet been designated as sales qualified leads. In example embodiments, opportunity analysis module 118 may be configured to automatically evaluate all active opportunities that have been designated as being in the “connection” stage of the sales cycle for a defined duration of time. In example embodiments, opportunity analysis module 118 may be configured to automatically evaluate an open opportunity in the lead identification phase after that opportunity reaches a time threshold, for example after a defined duration of time has passed since the opportunity was first identified or opened, or was first designated as being in the “connection” stage of the sales cycle. In some example embodiments, opportunity analysis module 118 may be configured to evaluate an opportunity in the lead phase in response to a request received through a UE device 104. In some examples, for example if a specific opportunity record is not yet opened, opportunity analysis module 118 may be configured to monitor customers that have an account status indicator of “open opportunity”.

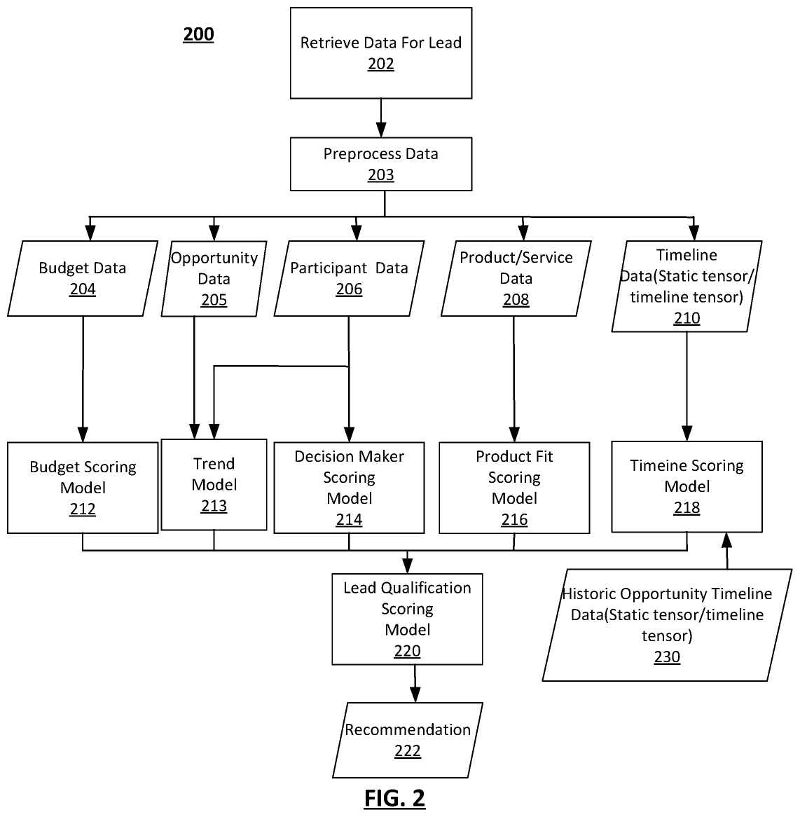

FIG. 2 illustrates a schematic diagram of a process 200 for determining if a lead for a target customer 190 should be classified as a qualified lead (e.g., determine when the sales cycle process for an opportunity has entered the “qualified lead” stage).

As indicated by Action 202, the opportunity analysis module 118 will retrieve data required to determine if a sales cycle process for an opportunity has achieved criteria required to complete the sales qualified lead stage. The data can be extracted from several sources. In example embodiments, data is retrieved from the CRM support system 120, including data objects 124 of the relationship database 122. As described above, CRM support system 120 collects information about customers 190, contacts 192, and opportunities 194, relationships and interaction activities from multiple sources and individuals over time, providing a centralized source of information about historic opportunities 194 and the current lead. In alternative embodiment, some or all of the data collection activities performed by CRM support system 120 can alternatively be performed by opportunity analysis module 118 or by other data collection components that can be queried by opportunity analysis module 118.

In example embodiments, opportunity analysis module 118 is configured to process the retrieved data for a customer 190 lead using multiple parallel scoring models, each of which generates a respective output. In the illustrated embodiment, these scoring models include: budget scoring model 212 for processing budget data 204; trend model 213 and decision-maker scoring model 214 for processing participant data 206 and possibly opportunity data 205; product fit scoring model 216 for processing product/service data 208; and timeline scoring model 218 for scoring timeline data 218. The respective outputs generated by the scoring models 212, 214, 216, 218 in respect of customer opportunity are collected and processed by a lead qualification scoring model 220, which generates a recommendation 222 as to whether or not the customer opportunity can be classified as being in the qualified lead stage of a sales cycle.

In some examples, one or more of the models 212 to 220 may be rules-based models that perform a scoring function to generate a score based on a set of predefined, software implemented rules that have been developed by a human programmer. In some examples, models 212 to 220 may be a mix of AI based models and rules based models.

In example embodiments, the extracted data that is retrieved as part of Action 202 will be preprocessed (Action 203) to organize and represent the data in defined formats for each of the respective models 212 to 218. In some examples, data may be preprocessed when it is originally being collected for data objects 124 in anticipation that the data will be retrieved for future processing by opportunity analysis module 118. For example, feature embedding that is performed by NLP module 117 in respect of electronic and audio communications may be performed in a manner such that the data required by opportunity analysis module 118 is stored and available in a processing friendly embedded format as part of activity data 136. In other examples the available data may be in a raw format or other format that requires additional processing at preprocessing Action 203.

Each of the respective scoring models 204 to 218 will now be described in greater detail.

Budget scoring model 212 is configured to process budget data 204 that is extracted from communication activities in respect of target customer 190 lead. Budget data 204 can be derived from the content of communications activities that pertain to whether a budget has been set for the lead by the customer 190 and the quantum of such budget. For example, NLP module 117 may be configured to classify text and text phrases that relate to budget matters that appear in electronic communications and VOIP communications that are logged in activity records 138 of the CRM support system 120. For example. NLP module 117 may be configured to recognize and generate embeddings (for example representative feature tensors) in respect of phrases that appear in emails or in text conversions of audio communications such as “we have a budget of $100K”; “We have about $500 per unit for 100 units to spend”; “I am authorized to put $60K into this project”; “I think we can budget $45,000”; “We have no idea about budget yet”; “We . . . ahhh . . . are expecting a spend of about half a million”. The embeddings for these phrases can be stored as part of the activity records 138, and may be classified as “budget” data. This NLP extracted data can also include, in the case of voice over IP calls, information about ‘non-verbal’ communication such as, but not limited to, tonality, pace of conversation, and pauses to add details on ‘how it is said’ with regards to a transcript alone.

In some examples the extracted budget data 204 may include time stamped data extracted from multiple communications activities that have occurred over a predefined time period—for example from the time the target customer lead was first opened to the time of performing the qualification analysis.

Budget data can also include information taken from the customer data 126 or opportunity data for the opportunity, including for example data from the “Projected budget” field. In example embodiments, budget scoring model 212 can compare the projected number with information extracted from the text of communications activities.

In some examples, the NLP extracted data from communications activities can be analyzed to determine if the budget numbers include in such communications are changing. An increase in the magnitude of the budgeted values can be interpreted as increased commitment on the part of the customer, justifying a higher budget score. Conversely, a decrease in the magnitude of the budgeted values may be indicative of decreased commitment on the part of the customer, justifying a lower budget score. In example embodiments, a budget trend indicator is periodically updated and stored as part of the ongoing updating of opportunity data 128.

In example embodiments, budget scoring model 212 is configured to generate a budget score based on the extracted budget data 204. For example, numeric scores could be generated that have the following mappings:
Score 1=No budget discussed
Score 2=Budget is too low
Score 3=Budget sufficient, but tentative
Score 4=Budget sufficient and firm
Score 5=Minimum sufficient budget is firm, upsell opportunity exists

In at least some examples, the quantum for a sufficient budget may be a predefined amount, and in some examples, the sufficiency of the budget may be determined based on the information included in the electronic and voice data embeddings included in the extracted data. In some examples, non-verbal data (e.g., pauses, tonality, pace) and context words (e.g., “about”, “maybe”, approximate, “roughly”, “firm”) may be used to classify the budget score as being tentative (Score 3), Firm (Score 4), or Firm with upsell opportunity (Score 5).

In some examples, budget scoring model 212 may be an AI based model that has been trained using historic opportunity data. For example, budget data (including amounts, trends, semantic indicators) for past opportunities that are known to be successful and unsuccessful can be used as a training dataset for a machine learning based model that is trained to map the budget data to respective budget scores. In some examples, budget scoring model 212 may be rules-based—for example, it may look for an increasing trend in the use of the “budget” related words and dollar values over a time period to determine budget score. In some examples, budget scoring model 212 may have more or less that than 5 possible output score categories, and in other example embodiments the generated output may be binary (e.g., Yes/No vote as to whether budget data 204 indicates readiness for lead to be qualified.)

Trend model 213 to configured to process participant data 206 to determine if communication activity trends indicated if a lead should be qualified as a sales qualified lead. As described above, opportunity data 128 that is available in relationship database 122 can include one or more Enterprise—Customer Interaction Trend Indicator(s) that can indicate one or more trends in interactions between Contact Participants and User Participants over one or more defined time periods.

In example embodiments, Trend model 213 is configured to generate a trend score for the customer 190 lead based on one or more of the Enterprise—Customer Interaction Trend Indicator(s). For example, numeric scores could be generated that have the following mappings:
Score 1=Accelerating Negative Interaction Trend;
Score 2=Linear Negative Interaction Trend;
Score 3=Flat Interaction Trend;
Score 4=Linear Positive Interaction Trend; and
Score 5=Accelerating Positive Interaction Trend.

In some examples, trend model 213 may include one or both of an AI based model (e.g., a machine learning model) that has been trained using historic opportunity data, and/or a programmer configured rules-based model. In some examples, trend model 213 may have more or less than 5 possible output score categories, and in other example embodiments the generated output may be binary (e.g., Yes/No vote as to trend sentiment.)

Decision maker scoring model 214 is configured to process participant data 206 to determine if an authorized decision maker on the part of customer 190 is sufficiently engaged in ongoing communications on the lead. As described above, opportunity data 128 that is available in relationship database 122 includes a main contact ID for a contact 192 within customer 190 that has been previously identified as the primary contact for the customer 190 lead. Contact data 130 available in relationship database 122 for identified main primary contact includes information that is indicative of the decision making ability of the identified main contact including: Position/Title, Department ID, Title Score, and Contact-Enterprise Relationship Score. User-Contact Relationship data 134 can identify other enterprise users 182 within the enterprise that the customer contact 192 has relationships with. Accordingly, such contact data is all retrieved during Action 202 to form part of participant data 206 (in some cases, after being subjected to further processing by preprocess data Action 203 to put the data in an appropriate format for decision maker scoring model 214).

In example embodiments, this main contact data can be supplemented by (i) information about who in the enterprise 180 and the customer 190 has been participating in communications activities related to the lead (which can be extracted from the activity records 138 of activity data 136), as well as (ii) any content related to decision making authority included in the text or transcripts of such activities that is captured in the NLP data and sentiment indicator fields of the activity records. Accordingly, in example embodiments, when collecting substantive content and sentiment data about communications activities, NLP module 117 may be configured to recognize and embed text and text phrases that relate to identifying a decision maker (e.g., “Bob from procurement has the final say”) that appear in electronic communications and VOIP communications that are logged in activity records 138 of the CRM support system 120. Accordingly, NLP data that relates to decision making authority is also retrieved during Action 202 to form part of participant data 206 (in some cases, after being subjected to further processing by preprocess data Action 203 to put the data in an appropriate format for decision maker scoring model 214).

In example embodiments, decision maker scoring model 214 includes one or more functions that are configured to determine if: (i) the identified main primary contact appears to indeed have decision making authority, based on the categorical contact data and lead data retrieved in respect of the contact 192 (e.g., title score, department ID, contact-enterprise relationship score); and (ii) the NLP data regarding decision making authority supports a conclusion that the identified main contact does have the authority to make a decision (e.g., NLP analysis may be used to determine that a statement in an email that “Jane Smith is responsible for this acquisition” to conclude that Jane Smith is a decision maker, and this conclusion may be recorded as part of the opportunity and/or customer data). In some examples, the data that is collected as participant data 206 can also include categorical contact data information (e.g., title scores, relationship scores) for other customer contacts 192 that are logged in activity records 138 as being involved in communications activities related to the customer lead. That information can be combined with the participant data described above and used by decision maker scoring model 214 to determine if an individual contact 192 participating in the communications is authorized to make a decision even if that person is not the identified main primary contact.

In example embodiments, decision maker scoring model 214 is configured to generate a decision maker score for the customer 190 lead based on the participant data 206. For example, numeric scores could be generated that have the following mappings:
Score 1=Main primary contact is not participating sufficiently, and no person with decision maker authority is identified as participating;
Score 2=Main primary contact is participating, and no person with decision maker authority is identified as participating
Score 3=Main primary contact is participating, and another participating party has been identified with the decision maker authority but is not participating;
Score 4=Main primary contact is participating, and another participating party has been identified with the decision maker authority and is participating;
Score 5=Main primary contact is participating and is the decision maker.

Decision maker authority may, for example, mean the authority to make the decision to set a budget or otherwise justify that the lead be advanced to the next stage.

In some examples, decision maker scoring model 214 may include one or both of an AI based model (e.g., a machine learning model) that has been trained using historic opportunity data, and/or a programmer configured rules-based model. In some examples, decision maker scoring model 212 may have more or less than 5 possible output score categories, and in other example embodiments the generated output may be binary (e.g., Yes/No vote as to whether a person with decision making authority is engaged/participating in the transaction.)

Product fit scoring model 216 is configured to process product/service data 208 to determine if the correct type and scope of product, service, or feature is being offered to the customer 190 for the target lead. As described above, opportunity data 128 that is available in relationship database 122 includes information about the products/services that relate to the lead, and the projected unit volumes for such products and services.

In example embodiments, additional product/service data 208 is obtained from content related to product/service type and volume included in the text or transcripts of communications activities that are captured in the NLP data and sentiment indicator fields of the activity records that pertain to the customer 190 lead. Accordingly, in example embodiments, when collecting substantive content and sentiment data about communications activities, NLP module 117 may be configured to recognize and embed text and text phrases that relate to product/services types and volumes that appear in electronic communications and VOIP communications that are logged in activity records 138 of the CRM support system 120. For example, NLP data may be collected that represents mentions of product names, inquiries for more product information, inquires asking about specific features, or questions about timelines. Additionally, information can also be extracted from activity data 136 such as velocity of emails, response time, email length, number of topics in the email, and review of additions to the email.

In some examples, information can be scrapped from external sources for inclusion in product/service data, for example, occurrences of the customer being named in on-line media in conjunction with possible competing products and services. (e.g., external information such as, but not limited to, customer's website and news releases relating to the customer). The external resources can be searched for key product and features matches to include in product/service data.

In example embodiments, product/service scoring model 216 includes one or more functions that are configured to determine if the aggregated product/service data 208 indicates that the customer and the parties have come to a point in respective understating on what products/services should be the subject of an opportunity 194(k). In example embodiments, product fit scoring model 216 is configured to generate a product fit score for the lead based on the participant data 206. For example, numeric scores could be generated that have the following mappings:
Score 1=Product/service discussion in communication is inconsistent with lead data;
Score 2=Products/services are highly ambiguous;
Score 3=Products/services are correct, volumes need adjusting;
Score 4=Products/services are correct but additional products services can be added
Score=5 Products/services and volumes are all consistent.

In some examples, product/service scoring model 216 may include one or both of an AI based model that has been trained using historic opportunity data, and/or a programmer configured rules-based model. In some examples, decision maker scoring model 216 may have more or less than 5 possible output score categories, and in other example embodiments the generated output may be binary (e.g., Yes/No vote as to whether correct products/services have been defined for the customer 190 lead).

Thus, in some examples, product fit scoring model 216 will analyze data from communications activities, extracted using NLP, that pertains to products and features. This analysis will include, but not be limited to, entity extraction from email communications (mentions of product names, asking for more information, asking about specific features, or questions about timelines) and email data such as, but not limited to, velocity of emails, response time, email length, number of topics in the email, and review of additions to the email (equal or higher title scores). External information such as, but not limited to, information scraped from electronic sources such as the customer's website and news releases on news sites relating to the customer can be processed to retrieve product and feature matches. The product fit scoring model 216 can determine if an optimized product/service fit and feature fit from the enterprise offerings is included in the lead.

In some examples, timeline scoring model 218 is configured to determine, based on timeline data 210, if an opportunity in respect of the customer 190 lead is progressing in an expected manner. In this regard, in example embodiments, when collecting substantive content and sentiment data about communications activities, NLP module 117 may be configured to recognize and embed text and text phrases that relate to timelines, deadlines, or dates that appear in electronic communications and VOIP communications that are logged in activity records 138 of the CRM support system 120. This data can be included in timeline data 210. In some examples, data about the velocity of communications activities may also be included in timeline data 210 along with information about the customer and lead (e.g., customer size score, lead size score, relationship scores).

In some examples, preprocessing 203 of the data included in timeline data 210 can be used to generate, using predefined models, a static tensor representation and a timeline tensor representation for the customer 190 lead. Static tensor representation may for example include values that represent feature such as customer size score, opportunity size score, relationship scores. Timeline tensor representation may for example include values that represent time dependent feature such communication activity velocity, frequency and timing of occurrence of timing related terminology in communications, etc.

In example embodiments, a relationship database 122 is preconfigured with a historic opportunity dataset (not shown) that includes Historic Opportunity Timeline Data 230. Historic Opportunity Timeline Data 230 includes a set of static tensor representations and a timeline tensor representation that have each been determined using the same predefined models used to determine the corresponding tensors for the current target customer 290 lead.

In example embodiments, opportunity analysis module 118 is configured to retrieve Historic Opportunity Timeline Data 230. Timeline scoring model 218 is configured to: (i) match the current opportunity to a set of prior successful opportunities based on a similarity of the static tensor representation of the current lead to the static tensor representations of successfully closed historic opportunities included in historic opportunity timeline data 210; and (ii) identify differences between the timeline tensor representation of the current opportunity from the timeline tensor representations of the matching historic opportunities.

In example embodiments, timeline scoring model 218 is configured to generate a timeline score for the customer 190 lead based on the timeline tensor differences between the current lead and the matching historic opportunities. For example, numeric scores could be generated that have the following mappings:
Score 1=Target lead timeline is lagging historic opportunities by unacceptable amount;
Score 2=Target lead timeline is leading historic opportunities by unacceptable amount;
Score 3=Target lead timeline is lagging historic opportunities, but within acceptable range;
Score 4=Target lead timeline is leading historic opportunities, but within acceptable range;
Score 5=Target lead timeline is tracking historic opportunities.

Accordingly, in example embodiments, the timeline scoring model 218 compares the target lead with data for past successful opportunities to identify successful opportunities that are similar to the current lead. This data could include, but not be limited to, company size, lead size, similarities with industry verticals of existing clients, or relationship score. The timeline scoring model 218 will then generate a score indicating if the target customer 190 lead timeline compares to the timelines of historically successful leads.

In some examples, timeline scoring model 218 may include one or both of an AI based model that has been trained using historic opportunity data, and/or a programmer configured rules-based model. In some examples, timeline scoring model 218 may have more or less that than 5 possible output score categories, and in other example embodiments the generated output may be binary (e.g., Yes/No vote as to whether correct products/services have been defined for the lead).

Opportunity analysis module 118 includes an opportunity scoring model (for example, lead qualification scoring model 220) for processing the outputs from models 212, 213, 214, 216 and 218 to generate a recommendation as to whether an opportunity is ready to move to a next phase (for example to determine in an opportunity lead can be designated as a qualified lead at the current time). In some examples, lead qualification scoring model 220 may be a rules-based model that may make decisions based on the output of models 212 to 218 as well as from additional information included in the retrieved data from Action 202. Some examples of a rules based decision that may result in a positive recommendation could include:
Average score generated by models 212 to 218 must be at least 4;
In a binary scoring system, at least 3 of 5 scoring models 212 to 218, including the budget model 212, must provide a “Y” vote;
If the lead size score (from opportunity data 128) exceeds a threshold, then a score of 3 or higher for budget score and decision maker score are sufficient, regardless of other scores.

In some examples, lead qualification scoring model 218 may include an AI based model that has been trained using historic opportunity data. For example, the input data and outputs of models 212 to 218 for historic opportunities can be used to train an ML model. In some examples, models 212-220 may all be integrated into a common ML model.

The recommendation 222 generated by lead qualification scoring model 220 could, for example could one of:
Recommend not to designate lead as qualified lead at this time
Recommend to designate the lead as a qualified lead at this time

In some examples, if the recommendation is to designate the lead as a qualified lead, opportunity analysis module 118 may be configured to present a user 182 of UE device 104 with the option to confirm the designation, in which case the opportunity analysis module 118 may provide a message to CRM support system 120 to update the current sales cycle time line status of the customer 190 lead in the opportunity data 128 to “qualified lead”, with a timestamp.

In example embodiments, opportunity analysis module 118 can also be configured to generate lead specific feedback based on the individual scores output by modules 212 to 218. For example, a message could be generated for a user 182 indicating that “lead is not ready for lead qualification because budget score was low and product fit score was low: work with customer to ensure that budget is set and correct product/features are offered”.

In some examples, a positive recommendation 222 can be used to automatically update the phase status of an opportunity in the relationship data, for example from pre-sales qualified lead to a sales-qualified lead, and/or to update the current stage indicator (for example, to “presenting”). In at least some examples the updated opportunity phase and/or stage status is sent to the CRM system 200, which then triggers a predefined set of actions for CRM system 200. For example, CRM system 200 may be configured to automatically send notifications to one or more enterprise users or customer contacts and/or trigger one or more sales or marketing event recommendations based on the update.

Referring to FIG. 3, an example embodiment of a computer system 2010 for implementing one or more of the modules, systems and agents included in enterprise network 110, CRM system 200, and CRM support system 120 will be described. In example embodiments, computer system 2010 may be a computer server. The system 2010 comprises at least one processor 2004 which controls the overall operation of the system 2010. The processor 2004 is coupled to a plurality of components via a communication bus (not shown) which provides a communication path between the components and the processor 2004. The system comprises memories 2012 that can include Random Access Memory (RAM), Read Only Memory (ROM), a persistent (non-volatile) memory which may one or more of a magnetic hard drive, flash erasable programmable read only memory (EPROM) (“flash memory”) or other suitable form of memory. The system 2010 includes a communication module 2030.

The communication module 2030 may comprise any combination of a long-range wireless communication module, a short-range wireless communication module, or a wired communication module (e.g., Ethernet or the like) to facilitate communication through communication network 150.

Operating system software 2040 executed by the processor 2004 may be stored in the persistent memory of memories 2012. A number of applications 2042 executed by the processor 2004 are also stored in the persistent memory. The applications 2042 can include software instructions for implementing the systems, methods, agents and modules described above (including for example opportunity analysis module 118).

The system 2010 is configured to store data that may include data objects 124 in the case of CRM support system 120 and the campaign data of campaign database 300 in the case of campaign management system 290. The system 2010 may include an interactive display 2032 and other human I/O interfaces in the case of UE device 104.

The present disclosure may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure. All values and sub-ranges within disclosed ranges are also disclosed. Also, although the systems, devices and processes disclosed and shown herein may comprise a specific number of elements/components, the systems, devices and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

1. A computer implemented method for determining when an ongoing process between a first entity and a second entity has achieved a milestone, comprising:
tracking, over time, electronic communications exchanged between the first entity and the second entity;
computing when the milestone has been achieved based on a frequency of the electronic communications, participants of the electronic communications and a content of the electronic communications; and
sending a notification when the milestone has been achieved.

2. The method of claim 1 wherein the ongoing process is a sales process associated with an opportunity, wherein tracking the electronic communications comprises monitoring the participants of the electronic communications by extracting email address information from address fields of the electronic communications at an email server of the first enterprise and time stamp data for the electronic communications.

3. The method of claim 2 wherein the milestone corresponds to an allocation of additional resources of the first entity to the ongoing process.

4. The method of claim 2 wherein computing if the milestone has been achieved comprises determining that a lead for the opportunity is a qualified lead.

5. The method of claim 2 wherein tracking the electronic communications comprises automatically extracting budget data from the content of the electronic communications that is indicative of a budget associated with the opportunity, and wherein computing when the milestone has been achieved is based on at least one of the following: a number of the electronic communications that the budget data is extracted from; a sentiment indicated in the budget data as determined using natural language processing (NLP); or an amount indicated in the budget data.

6. The method of claim 5 wherein computing when the milestone has been achieved is based on a change in a frequency in the number of electronic communications that the budget data is extracted from and/or changes in the amount indicated in the budget data that is extracted from different electronic communications.

7. The method of claim 2 comprising computing a communication trend indicator based on changes in the frequency of the electronic communications in different time durations, wherein computing when the milestone has been achieved is based on the communication trend indicator.

8. The method of claim 2 comprising computing a relationship score based on a number of at least some of the electronic communications, wherein computing when the milestone has been achieved is based on the relationship score.

9. The method of claim 2 wherein comprises determining a number of the electronic communications that a decision maker associated with the second entity is a participant of, wherein computing when the milestone has been achieved is based on the determined number.

10. The method of claim 9 comprising determining that one of the participants is the decision maker associated with the second entity based on NLP based analysis of the content of one or more of the electronic communications.

11. The method of claim 2 comprising computing, based on an NLP analysis of the content of the electronic communications, a score indicating that the first entity and the second entity have a common understanding of a product or service that is a subject of the sales process, wherein computing when the milestone has been achieved is based on the score.

12. The method of claim 11 wherein computing the score is further based on information scraped about the second enterprise from electronic sources that are external to the first enterprise.

13. The method of claim 2 further comprising processing a feature vector representing properties of the ongoing process using a model to compute a comparison score to determine how the ongoing process compares to historic processes, wherein computing when the milestone has been achieved is based on the comparison score.

14. The method of claim 1, comprising:
applying a first scoring model to determine a first score based on the frequency of the electronic communications;
applying a second scoring model to determine a second score based on the participants of the electronic communications;
applying a third scoring model to determine a third score based on the content of the electronic communications; and
wherein computing when the milestone has been achieved comprises applying a fourth model to determine if the milestone has been achieved based on the first score, the second score and the third score.

15. The method of claim 14 wherein at least one of the first, second, third or fourth models comprises a trained machine learning model.

16. A system for determining when an ongoing process between a first entity and a second entity has achieved a milestone, the system, comprising:
one or more processors;
one or more memories storing software instructions that when executed by the one or more processors configure the system to:
track, over time, electronic communications exchanged between the first entity and the second entity;
compute when the milestone has been achieved based on a frequency of the electronic communications, participants of the electronic communications and a content of the electronic communications; and
generate a notification when the milestone has been achieved.

17. The system of claim 16 wherein the ongoing process is a sales process associated with an opportunity, wherein the electronic communications are tracked to monitor the participants of the electronic communications by extracting email address information from address fields of the electronic communications at an email server of the first enterprise and time stamp data for the electronic communications.

18. The system of claim 17 wherein the software instructions configure the system to:
apply a first scoring model to determine a first score based on the frequency of the electronic communications;
apply a second scoring model to determine a second score based on the participants of the electronic communications;
apply a third scoring model to determine a third score based on the content of the electronic communications; and
apply a fourth scoring model to compute when the milestone is achieved based on the first score, the second score and the third score.

19. The system of claim 18 wherein at least one of the first, second, third or fourth models comprises a trained machine learning model.

20. A computer readable medium storing non-transitory instructions that, when executed by a computer system, configure the computer system to:
track, over time, electronic communications exchanged between the first entity and the second entity;
compute if or when the milestone has been achieved based on a frequency of the electronic communications, participants of the electronic communications and a content of the electronic communications; and
generate a notification when the milestone has been achieved.
